(19) United States
(12) Patent Application Publication
(10) Pub. No.: US 2014/0068251 A1
(43) Pub. Date: Mar. 6, 2014

(54) METHOD AND DEVICE FOR DYNAMICALLY UPDATING AND MAINTAINING CERTIFICATE PATH DATA ACROSS REMOTE TRUST DOMAINS

(71) Applicants: Ananth Ignaci, Lake-in-the-Hills, IL (US); Erwin Himawan, Chicago, IL (US); Anthony R. Metke, Naperville, IL (US); Shanthi E. Thomas, Carpentersville, IL (US)

(72) Inventors: Ananth Ignaci, Lake-in-the-Hills, IL (US); Erwin Himawan, Chicago, IL (US); Anthony R. Metke, Naperville, IL (US); Shanthi E. Thomas, Carpentersville, IL (US)

(73) Assignee: MOTOROLA SOLUTIONS, INC., SCHAUMBURG, IL (US)

(21) Appl. No.: 13/601,214

(22) Filed: Aug. 31, 2012

(51) Int. Cl. H04L 29/06

(52) U.S. Cl. CPC H04L 63/0823
USPC 713/158; 713/156

(57) ABSTRACT

A method and device is provided for dynamically maintaining and updating public key infrastructure (PKI) certificate path data across remote trusted domains to enable relying parties to efficiently authenticate other nodes in an autonomous ad-hoc network. A certificate path management unit (CPMU) monitors a list of sources for an occurrence of a life cycle event capable of altering an existing PKI certificate path data. Upon determining that the life cycle event has occurred, the CPMU calculates a new PKI certificate path data to account for the occurrence of the life cycle event and provides the new PKI certificate path data to at least one of a relying party in a local domain or a remote CPMU in a remote domain.

### FIELD OF THE DISCLOSURE

The present invention relates generally to wireless communication networks, and in particular, to dynamically updating certificate path data within a local domain and across remote trusted domains.

### BACKGROUND

In cryptography, a Certificate Authority (CA) is an entity that issues data structures (referred to as certificates) that bind specific identities to specific public keys and usage information via digital signatures. One well known format for certificate is defined by the Telecommunication Standardization Sector (ITU-T) in ITU-T Recommendation X. 509. The certificate certifies ownership of a public key by a named subject of the certificate. This allows others (relying parties) to rely upon signatures or assertions made by a private key that corresponds to the certified public key. Public Key Infrastructure (PKI) systems, built upon asymmetric cryptographic systems, can be used to enable mobile devices to authenticate one another. A common PKI framework is described in the Internet Engineering Task Force (IETF) Request for Comment (RFC) 5280. Certificates may identify non-CA entities (referred to herein as an end entity) or other CAs. A certificate that identifies a CA is called a CA certificate. The entity identified in a certificate is called a certificate subject or a subject.

In a PKI system, the CA is a trusted entity that is trusted by both the subject (owner) of the certificate and the party relying upon the certificate. Entities, other than CAs, may establish trust relationships by showing one another their respective certificates issued by trusted CAs. Trust relationships among CAs can be used to build a certification path, which is a chain of certificates where each certificate in the chain is validated by a preceding certificate's public key (discussed in more detail below). An existing PKI certificate path data can be altered by a life cycle event which may be, for example, the issuance of a new CA certificate by a trusted CA, or the revocation or expiration of an existing trusted CA certificate. A new certificate may be obtained, for example, through processes known as Renewal or Rekeying. When a new certificate is issued to replace another certificate, the new certificate is issued with several fields identical to those in a previous certificate that the renewed or rekeyed certificate replaces. It is well known that certificate life cycle events can be managed by certificate life cycle management protocol (CMP) messages. CMP is being used here generically to refer to any of many well known protocols for managing certificate life cycle events. Examples of such protocols are defined in IETF RFCs 4210, 4211, and 5271.

In conventional PKI, the certificates of two communicating nodes may be signed by different CAs. For example, a node in a first domain (a local node) and a node in a second domain (a remote node) may have the same or different CAs as their trust anchors. The term trust anchor is used herein to refer to either a CA which is inherently trusted by a certificate verifier or relying party, or to the public key of such a CA. To establish a trust relationship between the local node and the remote node, a CA certificate trust path has to be established between the remote node's signing CA and at least one of the local node's trust anchor CAs in order for the local node to authenticate the remote node. When a certificate is produced by an entity, the verifier of the certification constructs a certificate path linking the verifier's trust anchor to the CA that has signed the certificate. In a multi-organizational environment, where each organization has its own PKI domain, applications supporting inter-organizational security require additional mechanisms to establish cross-organizational trust relationships.

Authentication is the process of proving ones identity to a second party. A relying party can authenticate a certificate subject by obtaining the subject's certificate and a chain of certificates linking the subject's certificate back to a trust anchor CA of the relying party, validating the certificates in the chain, and finally using the public key found in the subjects' certificate to validate a signature made with the private key associated with the public key found in the subjects certificate. Conventional PKI methods often provide a resource, such as a public key directory, that can be queried for public key certificates. Relying parties can access these directories to obtain the certificates needed to make a chain between the relying party's trust anchor CA and the entity being authenticated. However, nodes in mobile ad-hoc networks are sometimes not connected to network infrastructure. Thus, nodes in mobile ad-hoc networks may not be able to authenticate each other if the nodes have different signing CAs. Methods exist for pre-constructing PKI certificate paths at a centralized unit in order to minimize certificate path construction and validation time during certificate-based authentication. However, these methods do not dynamically update and maintain existing certificate paths when certificate life cycle events occur in a local domain and remote trusted domains. Without dynamic updates and maintenance of existing certificate paths, when a life cycle event occurs in either the local domain or one or more remote trusted domains, the system administrator in the domain in which the event occurred has to verify that the event has occurred, notify other domains that existing certificate path(s) have changed, regenerate a new certificate path for a node affected by the event, and distribute the updated certificate path to relying party(s) in the local domain and to other remote trusted domains.

Existing methods of centralized certificate path construction only provide the shortest path from a given starting CA to a target CA. The shortest path may be the most efficient trust path. However, the shortest path may not be adequate or available to facilitate a temporary transitive trust path during a life cycle event that occurs between two previously unknown units that do not have an existing direct trust relationship and that would like to use a third party to facilitate an indirect trust relationship.

Accordingly, there is a need for an improved method and device that is capable of dynamically updating certificate path data within the local domain and across remote trusted domains.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a network diagram illustrating components of an ad-hoc wireless communication network, according to some embodiments.

FIG. 2 is a block diagram illustrating components of a certificate path management unit (CPMU), according to some embodiments.

FIG. 3 is a general flow diagram illustrating a method for dynamically updating certificate path data within a local domain and across remote trusted domains, according to some embodiments.

FIG. 4 is a further general flow diagram illustrating a method for dynamically updating certificate path data across domains, according to some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Some embodiments are directed to a method and apparatus for dynamically maintaining and updating public key infrastructure (PKI) certificate path data across trusted domains to enable relying parties to efficiently authenticate other nodes in an autonomous ad-hoc network. A certificate path management unit (CPMU) monitors a list of sources for an occurrence of a life cycle event capable of altering an existing PKI certificate path data. For example, the CPMU monitors certificate directories for new CA certificates, or new certificate revocation lists (CRLS) that contain entries for revoked CA certificates. Upon determining that the life cycle event has occurred, the CPMU calculates a new PKI certificate path data to account for the occurrence of the life cycle event and provides the new PKI certificate path data to at least one of a relying party in a local domain or a remote CPMU in a remote domain.

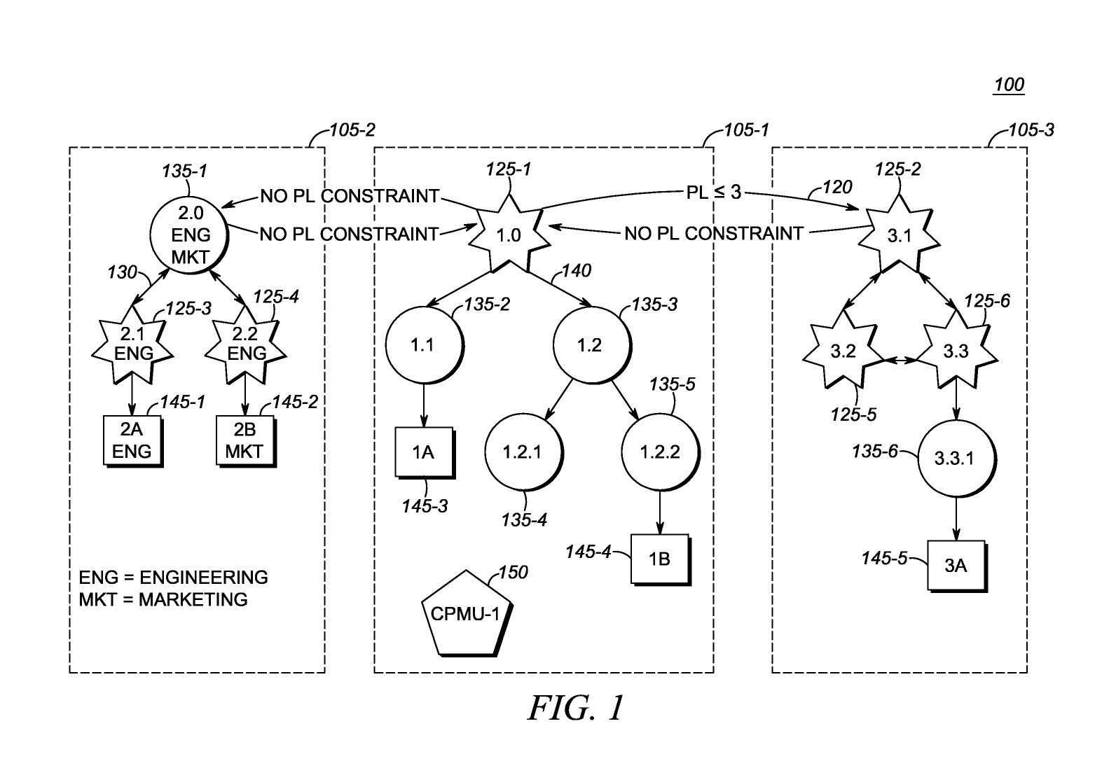

FIG. 1 is a block diagram of an ad-hoc wireless communication network 100 according to some embodiments of the present invention. The ad-hoc wireless communication network 100, for example, can include a mesh enabled architecture (MEA) network or an 802.11 network (for example, 802.11a, 802.11b, 802.11g, 802.11n or 802.11s). (For these and other IEEE standards, contact the IEEE at IEEE, 445 Hoes Lane, PO Box 1331, Piscataway, N.J. 08855-1331, USA.) It will be appreciated by those of ordinary skill in the art that the ad-hoc wireless communication network 100 can alternatively include any packetized communication network where packets are forwarded across multiple wireless hops. For example, the ad-hoc wireless communication network 100 can be a network utilizing multiple access schemes such as OFDMA (orthogonal frequency division multiple access), TDMA (time division multiple access), FDMA (Frequency Division Multiple Access), or CSMA (Carrier Sense Multiple Access).

Network 100 may include PKI systems, built upon asymmetric cryptographic systems, for enabling mobile devices to authenticate one another. Unlike symmetric key cryptography which uses a single key for encryption and decryption, asymmetric key cryptography uses a pair of keys, where one key in the pair is used for encryption and the other key in the pair can be used for decryption. The key used to encrypt data is known as the public key and can be made public without affecting the security of the encrypted data. The key used to decrypt the data is known as the private key and must be kept private. A private key can also be used for signing data while the corresponding public key can be used for validating the signature. As is known, in a PKI system, a Certificate Authority (CA) is a trusted entity that is trusted by both the subject (owner) of a certificate and the party relying upon the certificate. CAs may be trusted a priori based on their public keys that are known to be bound to their respective identities in advance. Entities, other than CAs, may establish trust relationships by showing one another their respective certificates issued by trusted CAs. There may be one or more CAs in a given PKI domain, wherein the trust relationships among the CAs may be hierarchical or a meshed.

Trust relationships among CAs can be used to build a certification path, which is a chain of certificates where each certificate in the chain is validated by a preceding certificate's public key. A certificate path (also referred to as a path) may include a list of CAs identified by a CA Distinguished Name, a CA certificate serial number, a CA certificate file name, an index into a certificate database, a relational database primary key or foreign key, and/or other fields or attributes. Normally, a CA path would be an ordered list of CAs although ordering is not necessary for storage of certificate path data. A certificate path may or may not be stored as a data structure containing a sequence of CA IDs. For example, a certificate path may include a relational database that includes a record for each CA, where each CA record includes a reference such as the foreign key that indicates to which path(s) the certificate belongs. A certificate path terminates with a certificate that has a trusted public key, so that a verifier of the certificate path can use the trusted public key (referred to as a trust anchor of the verifier) to verify a certificate at the other end of the certificate path. The term trust anchor is used herein to refer to either a CA which is inherently trusted by a certificate verifier or relying party, or to the public key of such a CA.

A trusted CA is one for which there may exist a chain of valid certificates rooted at a trust anchor of a relying party. A chain of certificates is a set of two or more certificates such that for at least one certificates in the chain the subject of one certificate is the issuer of the next certificate in the chain. Typically, a chain begins with a trust anchor certificate and ends with an end entity certificate. In this case, the subject of a second certificate through the penultimate certificate is the issuer of the next certificate in the chain. A chain can be traversed from either end, so the terms “begin” and “end” of the chain can be used to refer to either the trust anchor or the end entity. When one end of a certificate chain is a trust anchor, the chain is said to terminate at the trust anchor or the chain may be said to be rooted at the trust anchor. It is common to refer to any portion of a certificate chain as a certificate chain as well. Therefore a certificate chain may be rooted at a trust anchor and extend to include only CA certificates, with no end entity certificate included.

A certificate path tree is a set of data that identifies all the certificate paths of all trusted CAs within a given scope. A certificate path tree may have a scope of a single trust anchor, in which case, it will include information about all the certificate paths of all CAs trusted by the single trust anchor. A certificate path tree may also have a scope defined by a relying party, in which case, the certificate path tree could have information about all certificate paths for CAs trusted by all trust anchor CAs which the relying party trusts. A certificate path tree may have wider or narrower scope.

When a first CA issues a CA certificate to second CA, if the second CA does not also issue a certificate to the first CA, the second CA is said to be subordinate to the first CA. It is well known that when a CA issues a certificate to subordinate CA, it may include in the subordinate CA certificate, constraints that can be used to indicate to a relying party rules about the types of certificates that the subordinate CA is authorized to issue. One type of constraint is known as a policy constraint. A policy constraint can be used to limit the policy identifiers placed into certificates issued by the subordinate CA. It is also well known that a trust path may be verified by validating the certificates in the chain corresponding to the path, and also by evaluating constraints and attributes contained within a certificate against local configuration data.

In a multi-organizational environment, where each organization has its own PKI domain, applications supporting inter-organizational security require additional mechanisms to establish cross-organizational trust relationships. One method for addressing interoperability issues to support inter-organizational security involves a technique known as cross signing, wherein CAs of different organizations each issue a certificate to the other CA(s), which enables members in one organization to trust certificates issued by each cross-certified CA. When two CAs issue a CA certificate to each other they are said to be cross signed. The acts of issuing such certificates is said to be cross signing. The two certificates issued by each CA for the other CA are sometimes referred to as cross signed certificates. To avoid scalability issues due to meshed CA cross-certification, a bridge CA may be used to cross sign with each participating CA, such that members of each organization can trust certificates issued by cross-certified CAs, because the cross certificated CAs are trusted by the bridge, and the bridge is trusted by a CA within the member's trusted domain.

Network 100 is shown to include a first administrative domain 105-1, a second administrative domain 105-2, and a third administrative domain 105-3. As shown, some policy constraint rules apply to communications between the administrative domains 105-1, 105-2, 105-3. For example, arrow 120 shows that communications between a trust anchor node 125-1 in the first administrative domain 105-1 and a trust anchor node 125-2 in the third administrative domain 105-3 must have a path length (PL) of no more than three hops. Further, a CA 135-1 in the second administrative domain 105-2 is restricted to certifying only marketing and engineering sectors of the network 100. Thus, a trust anchor node 125-3 is restricted to only the engineering sector, which includes a relying party 145-1, and a trust anchor node 125-4 is restricted to only the marketing sector, which includes a relying party 145-2.

The first administrative domain 105-1 also includes four certification authorities 135-2, 135-3, 135-4, 135-5, and two relying parties 145-3, 145-4. Further, the third administrative domain 105-3 includes two other trust anchor nodes 125-5, 125-6, a certification authority 135-6, and a relying party 145-5. A double-headed arrow between two nodes, such as the arrow 130, indicates that a valid pair of cross-signed certificate exists between the two nodes. A single-headed arrow between two nodes, such as the arrow 140, indicates that a valid one-direction signed certificate exists between the two nodes. That is, a single headed arrow indicates that the CA from which the arrow is pointing has issued a CA certificate to the CA to which the arrow is pointing.

Consider that a centralized unit in the form of a certificate path management unit (CPMU) 150 operating in the first administrative domain 105-1 generates a certificate path tree for the relying party 145-3. As shown, the trust anchor of the relying party 145-3 is specified as the trust anchor node 125-1. Further, consider that a policy constraint rule specified for the relying party 145-3 is “sector=Engineering”. Thus the CPMU 150 will construct a certificate path tree for the relying party 145-3 that satisfies that policy constraint rule. Because they are in the marketing sector and not in the engineering sector, the trust anchor node 125-4 and the relying party 145-2 will not be included in the certificate path tree constructed for the relying party 145-3.

Tables 1, 2 and 3 below illustrate a certificate path generation for the relying party 145-3. For purposes of clarity, the certificate path generation is broken down into three passes, where pass one is illustrated in Table 1, pass two is illustrated in Table 2, and pass three is illustrated in Table 3. However, those having ordinary skill in the art will recognize that the certificate path generation could be accomplished in any number of passes including a single pass, two passes, more than three passes, etc. Also, the Tables 1, 2, and 3 include alternative reference numerals, as shown in FIG. 1, where all nodes in the first administrative domain 105-1 are designated lx, all nodes in the second administrative domain 105-2 are designated 2×, and all nodes in the third administrative domain 105-3 are designated 3×.

In the first pass, the CPMU 150 generates a path tree extending from the trust anchor node 125-1 to a relevant set of target nodes. The target nodes are CAs for which there is a chain of certificates that chain to the relevant trust anchor. Table 1 includes the resulting path information, where the first column identifies a target node; the second column identifies a path from the target node to the trust anchor node 125-1; and the third column includes an aggregated path length from the trust anchor node 125-1 to the relevant target node, and policy constraints along the relevant path.

TABLE 1

| Target | Path | Computed Constraints Along Path |
|---|---|---|
| 1.1 | 1.0 | PL = 1, Sector = Any |
| 1.2 | 1.0 | PL = 1, Sector = Any |
| 1.2.1 | 1.2→1.0 | PL = 2, Sector = Any |
| 1.2.2 | 1.2→1.0 | PL = 2, Sector = Any |
| 3.1 | 1.0 | PL = 1, Sector = Any |
| 3.2 | 3.1→1.0 | PL = 2, Sector = Any |
| 3.2 | 3.3→3.1→1.0 | PL = 3, Sector = Any |
| 3.3 | 3.1→1.0 | PL = 2, Sector = Any |
| 3.3 | 3.2→3.1→1.0 | PL = 3, Sector = Any |
| 3.3.1 | 3.3→3.1→1.0 | PL = 3, Sector = Any |
| 3.3.1 | 3.3→3.2→3.1→1.0 | PL = 4, Sector = Any |
| 2.0 | 1.0 | PL = 1, Sector = Engineering, |
| | | Marketing |
| 2.1 | 2.0→1.0 | PL = 2, Sector = Engineering |
| 2.2 | 2.0→1.0 | PL = 2, Sector = Marketing |

In the second pass, specific constraints of the trust anchor node 125-1 are applied from a relevant target node toward the trust anchor node 125-1. That includes the path length constraint of PL≦3 that was sent from the trust anchor node 125-1 to the trust anchor node 125-2. Thus any entries in Table 1 having a path length>3 are removed. The results are shown in Table 2 below.

TABLE 2

| Target | Path | Computed Constraints Along Path |
|---|---|---|
| 1.1 | 1.0 | PL = 1, Sector = Any |
| 1.2 | 1.0 | PL = 1, Sector = Any |
| 1.2.1 | 1.2→1.0 | PL = 2, Sector = Any |
| 1.2.2 | 1.2→1.0 | PL = 2, Sector = Any |
| 3.1 | 1.0 | PL = 1, Sector = Any |
| 3.2 | 3.1→1.0 | PL = 2, Sector = Any |
| 3.2 | 3.3→3.1→1.0 | PL = 3, Sector = Any |
| 3.3 | 3.1→1.0 | PL = 2, Sector = Any |
| 3.3 | 3.2→3.1→1.0 | PL = 3, Sector = Any |
| 3.3.1 | 3.3→3.1→1.0 | PL = 3, Sector = Any |
| [symbol] | [symbol] | [symbol] |
| 2.0 | 1.0 | PL = 1, Sector = Engineering, |
| | | Marketing |
| 2.1 | 2.0→1.0 | PL = 2, Sector = Engineering |
| 2.2 | 2.0→1.0 | PL = 2, Sector = Marketing |

In the third pass, the CPMU 150 applies the node-specified policy constraint rule of “Sector=Engineering”. A final certificate path tree composed for the relying party 145-3 is thus shown in Table 3 below.

TABLE 3

| Target | Path | Computed Constraints Along Path |
|---|---|---|
| 1.1 | 1.0 | PL = 1, Sector = Any |
| 1.2 | 1.0 | PL = 1, Sector = Any |
| 1.2.1 | 1.2−>1.0 | PL = 2, Sector = Any |
| 1.2.2 | 1.2−>1.0 | PL = 2, Sector = Any |
| 3.1 | 1.0 | PL = 1, Sector = Any |
| 3.2 | 3.1−>1.0 | PL = 2, Sector = Any |
| 3.2 | 3.3−>3.1−>1.0 | PL = 3, Sector = Any |
| 3.3 | 3.1−>1.0 | PL = 2, Sector = Any |
| 3.3 | 3.2−>3.1−>1.0 | PL = 3, Sector = Any |
| 3.3.1 | 3.3−>3.1−>1.0 | PL = 3, Sector = Any |
| [symbol] | [symbol] | [symbol] |
| 2.0 | 1.0 | PL = 1, Sector = Engineering, |
| | | Marketing |
| 2.1 | 2.0>1.0 | PL = 2, Sector = Engineering |
| [symbol] | [symbol] | [symbol] |

After a certificate path tree, such as that shown in Table 3, and/or a trusted certification authority list, is transmitted to the relying party or node (RN) 145-3 from the CPMU 150, then the RN 145-3 possesses the required information for authenticating any node in the ad-hoc wireless communication network 100, even a node from a different administrative domain such as the second administrative domain 105-2 or the third administrative domain 105-3.

According to some embodiments, because a validated public key of all certification authority nodes in a certificate path tree created for a specific relying party, such as the relying party 145-3 in the example above, is sent to the specific relying party, the certificate path tree information can be considered redundant. A specific relying party, such as the relying party 145-3, thus can validate a certificate of a verified node by using the validated public key of the certification authority (CA) that has signed the certificate. Therefore, according to some embodiments, certificate path tree information can be omitted from PKI certificate path data sent to a relying party from a CPMU, and only a trusted certification authority list is sent to the relying party in a certificate path data message.

Further, according to some embodiments, a CPMU, such as the CPMU 150, can cache PKI certificate path data that are sent to a relying party. Such cached PKI certificate path data thereafter do not need to be regenerated, but can be reused and sent to other relying parties that have the same trust anchor as the relying party to which the data were originally sent.

In addition to generating certificate path data, the CPMU 150 is configured to dynamically update its locally stored certificate path data to account for changes in trust relationships within the CPMU's local domain or within domains with which the CPMU 150 has an established trust relationship. The certificate path data identifies each certificate in all paths between any trusted CA (whether in the local domain or a remote trusted domain) and the local domain's trust anchor(s). Changes in trust relationships that may trigger dynamic updates to certificate path data include life cycle events, such as revocation of an existing CA certificate, expiration of an existing CA certificate, renewal or rekey of an existing CA certificate, issuance of a new CA certificate, or issuance of a new cross-signed certificate for a CA in another domain. In some embodiments, the CPMU 150 generates an initial list of potential sources that include information associated with the certificate path data. The sources may include databases, such as a repository or certificate database that includes certificate links or information related to how certificate links for the certificate path data is stored. The stored links may be related to the CPMU 150, local CA(s), external CPMU links or cross-signed CPMU discovery. It should be noted that a domain may have more than one CPMU and/or repository. The CPMU may discover new sources and/or CA(s) from known sources and thereafter update its list of potential sources and CAs. In some embodiments, the CPMU may discover newly issued CA certificates or known CA certificates that affect stored certificate path data by using various query method. For example, the CPMU 150 may query one or more local repositories at pre-defined interval of time by using a timer, or as needed, and execute an appropriate query using, for example, LDAP, SQL, HTTP, FTP or TFTP to determine if there is are any changes in trust relationships. It should be noted that the CPMU 150 may pre-configure or dynamically construct the list of sources that it monitors. The list of monitored sources may include, for example, certificate repositories or CPMUs within the local PKI domain, certificate repositories or CPMUs in PKI domains with which the local PKI domain has cross-certified and/or new PKI domains that are identified when new cross-signed certificates are issued.

When the CPMU 150 scans or monitors identified repositories and detects a change to its local PKI topology, or receives a notification from a remote CPMU to indicate that a life cycle event has occurred in a remote domain, the CPMU 150 may automatically calculate a new set of certificate path data for CAs in the topology of trusted CAs. The CPMU 150 stores the new data in a certificate path database and subsequently makes this data available to relying parties within its domain, and possibly makes this data available to other CPMUs in remote domains. Embodiments facilitate backward interoperability between a PKI system which is provisioned with a CPMU and with another PKI system which is not provisioned with a CPMU.

As noted, the CPMU 150 may pre-compile all possible certificate data paths within the CPMU's own administrative domain as well as domains with which the CPMU has cross-certified. The CPMU information may obtain CPMU information during the cross-signing between two PKI domains by exchanging CPMU certificates as part of the cross-signing procedure. In some embodiments, the CPMU 150 may monitor certificate repositories in its own administrative domain and may send digitally signed notifications to remote CPMU(s) of other domains with which the CPMU 150 has cross-certified, whenever there is a change in the certificate data path database(s) in the CPMU 150 domain.

Consequently, the remote CPMUs may use these signed notifications to update their certificate path databases to reflect the change that occurred in a trusted remote domain, in this case in the CPMU 150 domain. In one embodiment, the notification may only inform the remote CPMUs that a CA topology change has occurred and the remote CPMUs may then access the repository of the notifying CPMU, in this case CPMU 150, to determine the change. In another embodiment the notification may include the entire updated certificate path tree of the administrative domain of the CPMU 150. In yet another embodiment, the notification may include the certificates of newly added CAs or the serial numbers of revoked CA certificates. It should be noted that the notification may include information that is sufficient to enable the remote CPMUs to determine the change that occurred in the notifying CPMU's domain.

In other embodiments, the CPMU 150 may monitor the certificate repository of each administrative domain with which the CPMU 150 has cross-certified. When there are changes, such as revoked or expired CAs or newly added CAs, to the monitored domain(s), the CPMU 150 detects these changes to the monitored domains and re-generates or updates the stored certificate path.

In some embodiments, each CPMU may have a certificate issued by its local CA, wherein the CPMU issued certificate includes a pointer to the location of the CPMU, such as a Uniform Resource Locator (URL) of the CPMU, and an attribute that globally identifies the subject of the issued certificate as a CPMU. As part of the cross-signing procedure, domains that have CPMUs also exchange these CPMU certificates. This provides an avenue for the two domains to learn the locations of each other's CPMUs, thereby enabling one domain to learn the certificate path tree of another domain. Alternatively, when domains cross-sign, they need not exchange CPMU certificates because a local CPMU may be configured to discover the cross-signed certificate for the remote domain in the local domain's repository. The local CPMU can use the cross-signed certificate for the remote domain to access the remote domain's repository to determine if it includes a CPMU certificate for a remote CPMU, and if so, the local CPMU can automatically establish communications with the remote CPMU.

In another embodiment, when a local domain cross-signs with a remote domain and the local domain does not have a CPMU, the local domain may issue a new certificate for its certificate repository. This certificate includes a pointer to the location of the certificate repository, such as a URL for the certificate repository, and an attribute which globally identifies the subject of the issued certificate as the certificate repository. As part of the cross-signing procedure, the local domain sends this repository certificate to remote domains with which it is crossed-certified. This provides an avenue for the local domain to enable a remote domain with a CPMU to learn the local domain's certificate path tree. Alternatively, a field, including a pointer such as a URL of the subject CA repository, can be added to the CA certificate. Accordingly, in some embodiments, the CPMU 150 may discover a new certificate by determining if a newly found CA certificates is from another domain. The CPMU 150 may also determine if a CPMU location attribute is included in the certificate. If there is a CPMU location attribute in the certificate, the CPMU 150 may then establish communication with the remote CPMU and send an inter-CPMU message to the CPMU identified by the CPMU location attribute in the certificate. If the CPMU location attribute does not include a CPMU location, the CPMU 150 may check to see if there is a repository location as part of this attribute. If a repository location is provided, then CPMU 150 establishes connection with the remote repository and queries it to obtain the list of newly added CA certificates or revoked CA certificates.

Additionally, the CPMU 150 can also detect newly cross-signed certificates with a CA from a new administrative domain. In one embodiment, the CPMU 150 can be manually provisioned with an address or URL of a remote CPMU of a new domain (if it exists) or a certificate repository of the new domain. When the remote CPMU exists for the new domain, the CPMU 150 may request the certificate path tree for this new domain from the remote CPMU and the CPMU 150 uses this information to regenerate its own certificate path tree. However, if the remote CPMU does not exist in the new administrative domain, the CPMU 150 may generate the certificate path tree of the new domain by querying the certificate repository of the new domain.

Inter-CPMU Messages used to handle communications between CPMUs may include a subscribe message, a request message, and a reply message. The subscribe message is used to establish a relationship between two CPMUs, for example a local CPMU and a remote CPMU, and is used by each CPMU to request that certificate path tree updates be sent automatically from the other CPMU. The subscribe message may include a type field that indicates that the message is a subscribe message and a local domain identifier field that identifies the domain of the requesting CPMU, for example the CPMU 150. If, for example, CPMU 150 is requesting certificate path tree updates, CPMU 150 may send a request message to a remote CPMU to request an entire certificate path tree. The request message may include a type field that indicates that the message is a request message and a local domain identifier field that identifies the domain of the requesting CPMU, in this case CPMU 150. The remote CPMU may use the local domain identifier provided in the request message to exclude path tree branches pertaining to the requesting domain.

In response to the request message, the remote CPMU may return a reply message to the requesting CPMU. The reply message is an inter-CPMU message that may include information about a remote certificate path tree. The reply message in some embodiments may include two types of directives, add branch directive and delete branch directive, wherein each reply message may include any number of add branch and/or delete branch directives. The add branch directive may include a type field to indicate that the directive is an add branch directive, a subject key identifier field, a parent authority key identifier field and one or more policy constraints fields. The delete branch directive may include a type field to indicate that the directive is a delete branch directive, a subject key identifier field, and a parent authority key identifier field. The reply message sent from the remote CPMU to the requesting CPMU includes a type field that indicates that the message is a reply message, a number of directives field for indicating the number of directives in the reply message and a field for each directive in the reply message.

The CPMU 150 is therefore able to locate other CPMUs from remote trusted domains. For example, the CPMU 150 may locate other CPMUs through the use of a certificate with a new CPMU attribute. The CPMU 150 can also notify other CPMUs when it detects a new cross-sign, revocation, or addition of new CA(s) within its provisioned administrative domain. Therefore, embodiments support the automated updating of certificate path data across remote trusted domains, where the CPMU 150 is able to dynamically update its existing certificate path data when the CPMU 150 detects the occurrence of a life cycle event in its domain or when the CPMU 150 is notified that a life cycle event occurred in a remote cross-certified domain.

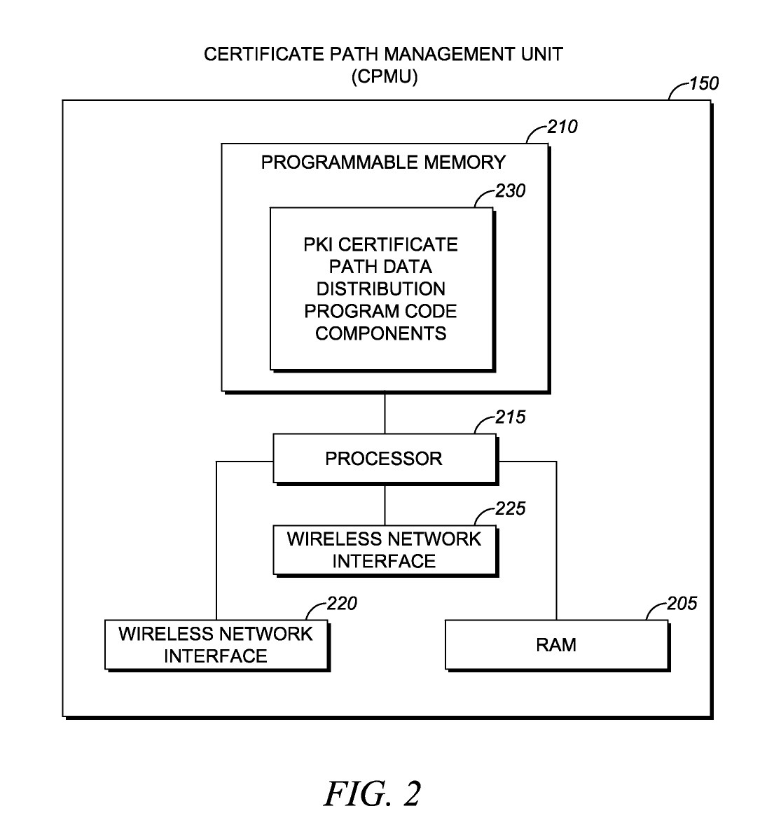

FIG. 2 is a block diagram that illustrates components of a certificate path management unit (CPMU), such as the CPMU 150, according to some embodiments. The CPMU 150, for example, can be an integrated unit containing at least all the elements depicted in FIG. 2, as well as any other elements necessary for the CPMU 150 to perform its particular functions. Alternatively, the CPMU 150 can include a collection of appropriately interconnected units or devices, wherein such units or devices perform functions that are equivalent to the functions performed by the elements of the CPMU 150.

The CPMU 150 includes a random access memory (RAM) 205 and a programmable memory 210 that are coupled to a processor 215, such as one or more microprocessors, microcontrollers, digital signal processors (DSPs), combinations thereof or such other devices known to those having ordinary skill in the art. The processor 215 also has ports for coupling to wireless network interfaces 220, 225. The wireless network interfaces 220, 225 can be used to enable the CPMU 150 to communicate with other node devices in an ad hoc wireless network or mesh network, such as the ad hoc wireless network 100. For example, the CPMU 150 can communicate with the relying party 145-3 using the wireless network interface 220 to receive and route data packets.

The programmable memory 210 can store operating code (OC) for the processor 215 and code for performing functions associated with a CPMU. For example, the programmable memory 210 can include PKI certificate path data, and computer readable program code components 230 configured to cause execution of a method for distributing PKI certificate path data as described herein. The processor 215 is configured to implement, based on data and operating code maintained by the programmable memory 210, a monitoring unit that, among other functions, is configured to monitor a list of sources for an occurrence of a life cycle event capable of altering an existing PKI certificate path data, to monitor a certificate repository associated with each administrative domain with which the CPMU is cross-certified, and to monitor a local certificate repository for a change in existing PKI certificate path data, a determining unit that is, among other functions, configured to determine that the life cycle event has occurred, a calculating unit that is, among other functions, configured to calculate a new PKI certificate path data to account for the occurrence of the life cycle event, and a notifying unit that is, among other functions, configured to provide the new PKI certificate path data to at least one of a relying party in a local domain or a remote CPMU in a remote domain, to send a digitally singed notification to a remote CPMU when a change is determined in a local certificate repository, and to send a notification from the CPMU to a remote CPMU, for example, that informs a remote CPMU of a certificate authority topology change in the local domain, wherein the remote CPMU is configured to access a local certificate repository associated with the CPMU to obtain the new PKI certificate path, that comprises the new PKI certificate path, and/or that comprises a certificate of a newly added CA or a serial number of a revoked CA certificate in the domain of the CPMU.

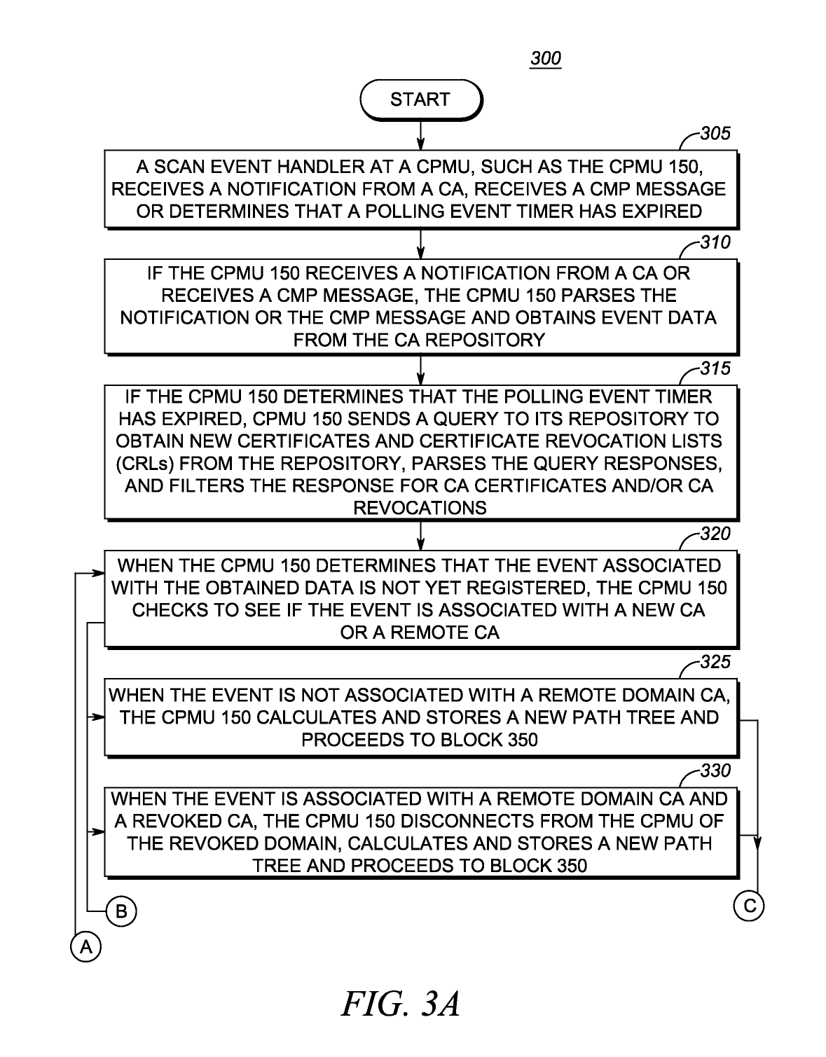

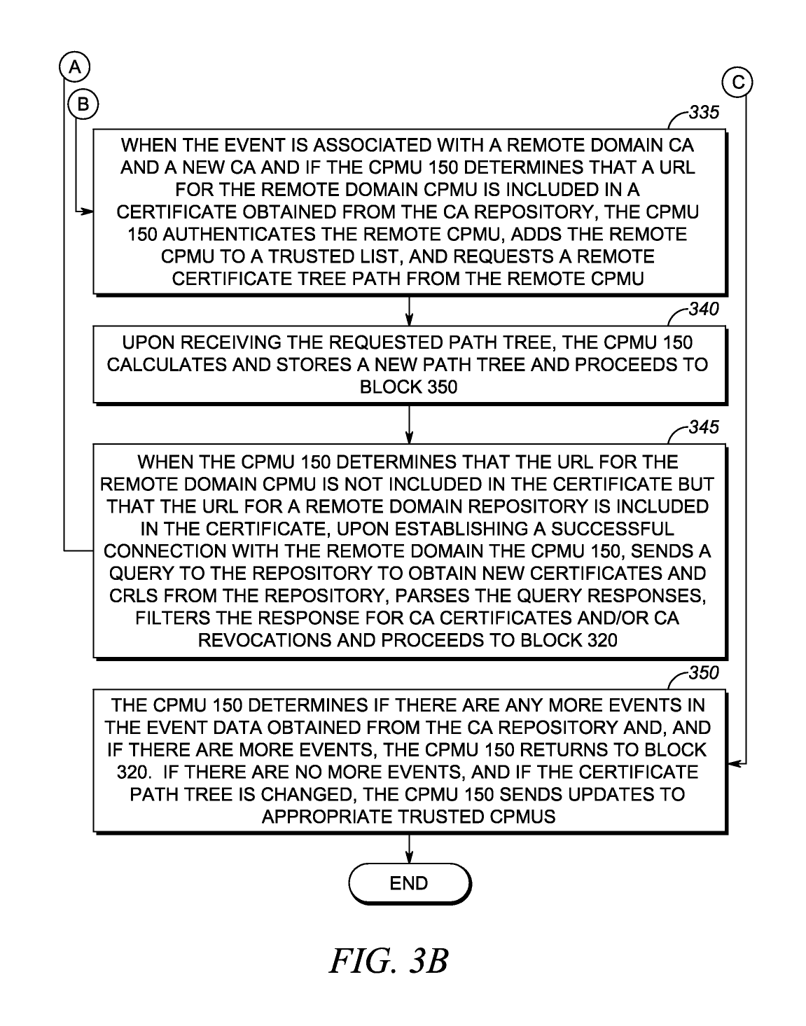

FIG. 3 is a general flow diagram that illustrates a method 300 for updating of certificate path data across remote trusted domains, according to some embodiments. For example, at block 305, consider that a scan event handler at a CPMU, such as the CPMU 150, receives a notification from a CA, receives a CMP message or determines that a polling event timer has expired. At block 310, if the CPMU 150 receives a notification from a CA or receives a CMP message, the CPMU 150 parses the notification or the CMP message and obtains event data from the CA repository. The event data obtained from the CA repository may include cross-signed certificates, CA certificates, revoked cross-signed certificates, or revoked CA certificates. At block 315, if the CPMU 150 determines that the polling event timer has expired, CPMU 150 sends a query to its repository to obtain new certificates and certificate revocation lists (CRLs) from the repository, parses the query responses, and filters the response for CA certificates and/or CA revocations.

At block 320, when the CPMU 150 determines that the event associated with the obtained data is not yet registered, the CPMU 150 checks to see if the event is associated with a new CA or a remote CA and proceeds to either block 325, 330 or 335. At block 325, when the event is not associated with a remote domain CA, the CPMU 150 calculates and stores a new path tree and proceeds to block 350. At block 330, when the event is associated with a remote domain CA and a revoked CA, the CPMU 150 disconnects from the CPMU of the revoked domain, calculates and stores a new path tree and proceeds to block 350. At block 335, when the event is associated with a remote domain CA and a new CA and if the CPMU 150 determines that a URL for the remote domain CPMU is included in a certificate obtained from the CA repository, the CPMU 150 authenticates the remote CPMU, adds the remote CPMU to a trusted list, and requests a remote certificate tree path from the remote CPMU and proceeds to block 340. At block 340, upon receiving the requested path tree, the CPMU 150 calculates and stores a new path tree and proceeds to block 345. At block 345, if the CPMU 150 determines that the URL for the remote domain CPMU is not included in the certificate but that the URL for a remote domain repository is included in the certificate, upon establishing a successful connection with the remote domain the CPMU 150, sends a query to the repository to obtain new certificates and CRLs from the repository, parses the query responses, filters the response for CA certificates and/or CA revocations and proceeds to block 320.

At block 350, the CPMU 150 determines if there are any more events in the event data obtained from the CA repository and, and if there are more events, the CPMU 150 returns to block 320. If there are no more events, and if the certificate path tree is changed, the CPMU 150 sends updates to appropriate trusted CPMUs.

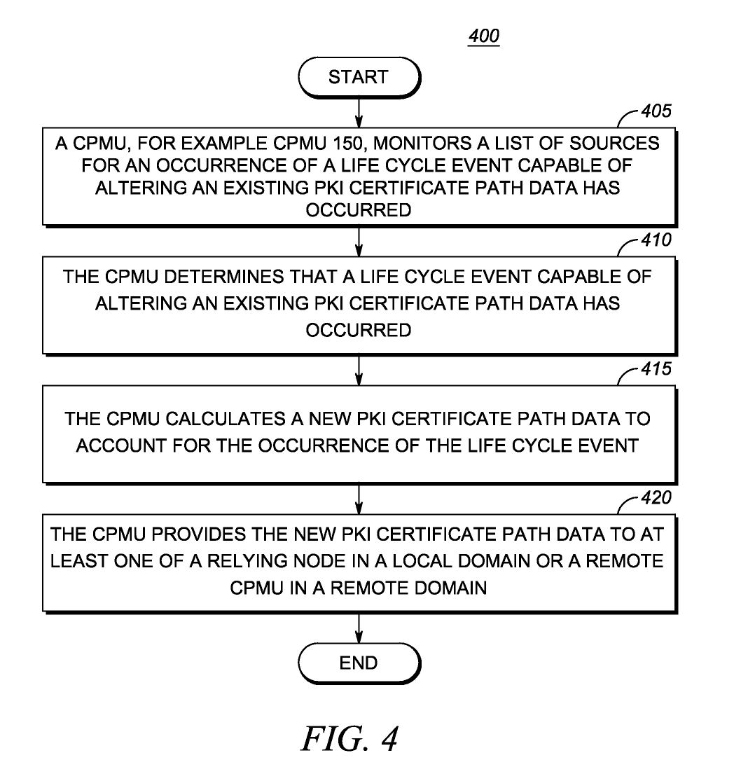

FIG. 4 is a general flow diagram that illustrates a method 400 updating of certificate path data across remote trusted domains, according to some embodiments. At block 405, a CPMU, for example CPMU 150, monitors a list of sources for an occurrence of a life cycle event capable of altering an existing PKI certificate path data has occurred. At block 410, the CPMU 150 determines that a life cycle event capable of altering an existing PKI certificate path data has occurred. At block 415, the CPMU calculates a new PKI certificate path data to account for the occurrence of the life cycle event. At block 420, the CPMU provides the new PKI certificate path data to at least one of a relying party in a local domain or a remote CPMU in a remote domain.

Embodiments may therefore be used for efficient certificate path construction and validation in systems with large and complex PKI topologies. For example, public safety incident scene customers requiring multi agency interoperability can benefit from embodiments described herein by ensuring that certificate path data is properly updated and that this data is promptly and reliably made available to all necessary parties. Therefore, embodiments eliminate the need for human interventions and thus the possibility of human error in the updating and maintenance of certificate path data across remote trusted domains.

Advantages of some embodiments of the present invention therefore include enabling, in an ad hoc wireless network, an efficient distribution of PKI certificate path data to all trusted nodes. That enables relying parties to authenticate other nodes and/or users in the network. Further, embodiments can accelerate certificate validation processes because construction of redundant certificate paths is reduced or eliminated. Also, validation processes between a CPMU and a relying party can be reduced to a single verification.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the present teachings. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “includes,” “comprising,” “has”, “having,” “includes”, “including,” “contains”, “containing” or any other variation thereof, are intended to cover a non-exclusive inclusion, such that a process, method, article, or apparatus that includes, has, includes, or contains a list of elements does not include only those elements but may include other elements not expressly listed or inherent to such process, method, article, or apparatus. An element preceded by “includes a . . . ”, “has a . . . ”, “includes a . . . ”, or “contains a . . . ” does not, without more constraints, preclude the existence of additional identical elements in the process, method, article, or apparatus that includes, has, includes, or contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be included of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and system described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for dynamically updating public key infrastructure (PKI) certificate path data, the method comprising:
monitoring, at a certificate path management unit (CPMU), a list of sources for an occurrence of a life cycle event capable of altering an existing PKI certificate path;
determining, at the CPMU, that the life cycle event has occurred;
calculating, at the CPMU, a new PKI certificate path data to account for the occurrence of the life cycle event; and
providing the new PKI certificate path data to at least one of a relying party in a local domain or a remote CPMU in a remote domain.

2. The method of claim 1, wherein the list of sources is pre-configured or dynamically constructed and the list of sources includes at least one of:
certificate repositories or CPMUs within a local PKI domain;
certificate repositories or CPMUs in PKI domains with which the local PKI domain is cross-certified; or
new PKI domains that are identified when new cross-signed certificates are issued.

3. The method of claim 1, wherein the occurrence of the life cycle event includes revocation of an existing certificate authority (CA) certificate, expiration of the existing CA certificate, renewal or rekey of the existing CA certificate, issuance of a new CA certificate, or issuance of a new cross-signed certificate for a CA in another domain.

4. The method of claim 1, wherein the existing PKI certificate path data includes certificate data paths within either the local domain, or within the local domain and a remote domain.

5. The method of claim 1, wherein the monitoring comprises obtaining from a local certificate repository a set of life cycle events capable of altering the existing PKI certificate path data; and
wherein the providing comprises sending a digitally signed notification to the remote CPMU when a change is determined in the local certificate repository.

6. The method of claim 1, wherein the monitoring comprises obtaining a set of lifecycle events capable of altering the existing PKI certificate path from a certificate repository associated with each administrative domain with which the CPMU is cross-certified and receiving notifications from a CPMU in a remote domain.

7. The method of claim 1, wherein the providing comprises sending a notification from the CPMU to the remote CPMU, wherein the notification:
informs the remote CPMU of a certificate authority topology change in the local domain, wherein the remote CPMU is configured to access a local certificate repository associated with the CPMU to obtain the new PKI certificate path data;
comprises the new PKI certificate path data; or
comprises a certificate of a newly added certificate authority or a serial number of a revoked certificate authority certificate in the domain of the CPMU.

8. The method of claim 1, further comprising assigning a CPMU certificate to the CPMU, the CPMU certificate comprising a pointer to a location of the CPMU and an attribute to identify that the CPMU is the subject of the CPMU certificate,
wherein during cross-signing with a new remote domain, the CPMU in the local domain and a remote CPMU associated with the new remote domain exchange certificates as part of the cross-signing procedure, the CPMU sends the CPMU certificate to the new remote domain to provide an avenue for the remote CPMU associated with the new remote domain to determine the location of the CPMU and to obtain the new PKI certificate path data.

9. The method of claim 1, wherein the monitoring further comprises, at the CPMU:
discovering a cross-signed certificate for the remote domain in a local repository and connecting with a remote domain repository associated with the cross-signed certificate;
accessing the remote domain repository to obtain a certificate for the remote CPMU; and
establishing communications with the remote CPMU to provide the new PKI certificate path data.

10. The method of claim 1, further comprising issuing a repository certificate to a local repository in the local domain, wherein the repository certificate comprises a pointer to a location of the local repository and an attribute for identifying that the local repository is the subject of the repository certificate,
wherein during cross-signing with a new remote domain, the CPMU in the local domain and a remote CPMU associated with the new remote domain exchange certificates as part of the cross-signing procedure, the CPMU sends the repository certificate to the new remote domain to provide an avenue for the new remote domain to determine the location of the local repository and to calculate the new PKI certificate path data.

11. The method of claim 1, wherein a pointer to a location of a local repository is included in a CA certificate, wherein
during cross-signing with a new remote domain, the CPMU determines if a newly found CA certificate is from another domain;
determines that a CPMU location attribute is included in the newly found CA certificate, establishes communication with the CPMU associated with the CPMU location attribute and exchanges inter-CPMU messages with the CPMU associated with the CPMU location attribute; or
determines that the CPMU location attribute is not included in the newly found CA certificate but that the location of the local repository is included in the newly found CA certificate, establishes a connection with the local repository, queries the local repository to obtain a list of newly added CA certificates or revoked CA certificates and performs the calculating and providing.

12. The method of claim 1, wherein the CPMU and the remote CPMU exchange inter-CPMU messages including a subscribe message, a request message and a reply message.

13. A certificate path management unit (CPMU) configured to dynamically update public key infrastructure (PKI) certificate path data, the CPMU comprises:
a monitoring unit configured to monitor a list of sources for an occurrence of a life cycle event capable of altering an existing PKI certificate path data;
a determining unit configured to determine that the life cycle event has occurred;
a calculating unit configured to calculate a new PKI certificate path data to account for the occurrence of the life cycle event; and
a notifying unit configured to provide the new PKI certificate path data to at least one of a relying party in a local domain or a remote CPMU in a remote domain.

14. The CPMU of claim 13, wherein the monitoring unit is configured to monitor a local certificate repository for a change in the existing PKI certificate path data; and
the notifying unit is configured to send a digitally signed notification to the remote CPMU when a change is determined in the local certificate repository.

15. The CPMU of claim 13, wherein the monitoring unit is configured to monitor a certificate repository associated with each administrative domain with which the CPMU is cross-certified and upon receiving notification of a life cycle event in a monitored repository the CPMU is configured to calculate the new PKI certificate path data.

16. The CPMU of claim 13, wherein the notifying unit is configured to send a notification from the CPMU to the remote CPMU, wherein the notification one of more of:
informs the remote CPMU of a certificate authority topology change in the local domain, wherein the remote CPMU is configured to access a local certificate repository associated with the CPMU to obtain the new PKI certificate path data;
comprises the new PKI certificate path data; or
comprises a certificate of a newly added certificate authority or a serial number of a revoked certificate authority certificate in the domain of the CPMU.

17. The CPMU of claim 13, further comprising a CPMU certificate comprising a pointer to a location of the CPMU and an attribute to identify that the CPMU is the subject of the CPMU certificate and wherein during cross-signing with a new remote domain, the CPMU and a remote CPMU associated with the new remote domain exchange certificates as part of the cross-signing procedure, the CPMU sends the CPMU certificate to the new remote domain to provide an avenue for the remote CPMU associated with the new remote domain to determine the location of the CPMU and to obtain the new PKI certificate path data.

18. The CPMU of claim 13, further configured to:
discover a cross-signed certificate for the remote domain in a local repository and connect with a remote domain repository associated with the cross-signed certificate;
access the remote domain repository to obtain a certificate for the remote CPMU; and
establish communications with the remote CPMU to receive notification of a life cycle event in the remote domain and provide notification of the new PKI certificate path data to the remote CPMU.

19. The CPMU of claim 13, wherein the CPMU is associated a local repository, wherein a repository certificate to is assigned to the local repository and wherein the repository certificate comprises a pointer to a location of the local repository and an attribute for identifying that the local repository as the subject of the repository certificate and wherein during cross-signing with a new remote domain, the CPMU and a remote CPMU associated with the new remote domain exchange certificates as part of the cross-signing procedure, the CPMU sends the repository certificate to the new remote domain to provide an avenue for the new remote domain to determine the location of the local repository and to calculate the new PKI certificate path data.

20. The CPMU of claim 13, wherein a pointer to a location of a local repository is included in a CA certificate, wherein
during cross-signing with a new remote domain, the CPMU determines if a newly found CA certificate is from another domain;
determines that a CPMU location attribute is included in the newly found CA certificate, establishes communication with a CPMU associated with the location attribute, and exchanges inter-CPMU messages with the CPMU associated with the location attribute; or
determines that the CPMU location attribute is not included in the newly found CA certificate but that the location of the local repository is included in the newly found CA certificate, establishes a connection with the local repository, queries the local repository to obtain a list of newly added CA certificates or revoked CA certificates, and performs the calculating and notifying.

21. The CPMU of claim 13, wherein the CPMU and the remote CPMU exchange inter-CPMU messages including a subscribe message, a request message and a reply message.
